(19) United States
(12) Patent Application Publication
(10) Pub. No.: US 2018/0275389 A1
(43) Pub. Date: Sep. 27, 2018

(54) Remote Focusing All-Optical Digital Scanning Light Sheet Microscopy for Optically Cleared Tissue Sections

(71) Applicants: Duncan Ryan, Fort Collins, CO (US); THE REGENTS OF THE UNIVERSITY OF COLORADO, A BODY CORPORATION, Denver, CO (US)

(72) Inventors: Douglas Shepherd, Denver, CO (US); Duncan Ryan, Fort Collins, CO (US)

(21) Appl. No.: 15/764,830

(22) PCT Filed: Oct. 7, 2016
(86) PCT No.: PCT/US16/55945

§ 371 Date: Mar. 29, 2018

Related U.S. Application Data
(60) Provisional application No. 62/239,063, filed on Oct. 8, 2015.

(51) Int. Cl. G02B 21/24; G02F 1/29; G02B 21/06; G02B 21/36; G02B 21/02

(52) U.S. Cl. CPC G02B 21/244; G02F 1/29; G02B 21/368; G02B 21/367; G02B 21/02; G02B 21/06

(57) ABSTRACT

This application discloses a tools and techniques for using a remote-focusing element (such as an electro-tunable lens) to provide enhanced focusing in an all-optical digital scanning microscopy system. The remote-focusing element can imaging of different sections of the specimen without moving the specimen itself, while at the same time providing the ability to correct for non-uniform indices of refraction in the imaged specimen and/or the surrounding medium which can cause misalignment between the imaged plane and the illuminated plane, which can result in loss focus in the imaged section of the specimen. The remote-focusing element can also obviate the need to move the detection stage and/or the illumination stage of the system to image different sections, eliminating vibration during the imaging process.

### CROSS-REFERENCE TO RELATED APPLICATIONS

This application claims the benefit, under 35 U.S.C. § 119(e), of U.S. Patent Application No. 62/239,063, filed Oct. 8, 2015 by Shepherd et al. and entitled “Remote Focusing All-Optical Digital Scanning Light Sheet Microscopy for Optically Cleared Tissue Sections” (attorney docket no. 0195.CU3874H-PPA1), which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to light sheet microscopy, and more particularly to a remote autofocusing system for digital scanning light sheet microscopy of optically cleared tissue sections.

### BACKGROUND

Light sheet microscopy is a type of fluorescence microscopy capable of imaging a specimen by optical sectioning. Compared to other microscopy techniques for optical sectioning, light sheet microscopy generates a laser light-sheet to illuminate a specimen along only a single, thin plane orthogonal to the optical axis of the objective lens. Thus, under ideal conditions, only the imaged plane is illuminated by the laser light sheet, with the laser light sheet coinciding with the focal plane of the objective lens.

Accordingly, several advantages are afforded to light sheet microscopy. One of the advantages stems from the fact that, because the light sheet only illuminates the imaged plane as opposed to the entire specimen, light-induced damage of the specimen is reduced. This allows for more scans to be taken of a given specimen.

To construct a three dimensional image using light sheet microscopy, multiple optical sections, or slices, are sequentially captured and stitched together to form the three dimensional image in post processing. In order to capture the optical sections, conventional light sheet microscopy techniques require that the specimen be moved relative to the focal plane of the detecting objective. This is typically accomplished by either: movement of the specimen itself, or by coordinated movement of the light sheet and detection objective such that the light sheet remains synchronized with the focal plane of the detection objection.

Both of these approaches introduce a number of problems in alignment, scanning speed, light efficiency, specimen stabilization and durability, and vibration, among other issues.

Moreover, as only the imaged plane is illuminated by the light sheet, typically entering the specimen from one side, image resolution, brightness, and contrast of larger specimens are limited by the light scattering or absorption characteristics of the specimen. Similarly, the depth to which the specimen may be imaged may also be limited by the light scattering and absorption characteristics of the specimen. Structural and material variations within a specimen may further introduce artifacts to the imaged section.

Thus, to improve optical sectioning of a specimen, various clearing agents and techniques have been developed to render the tissue and other structures of a specimen transparent. However, clearing methods require harsh chemical agents and immersion media that may damage the tissue or structure of the specimens. When utilizing off-the-shelf objectives to image cleared samples, objectives are typically selected to match the refractive index of the cleared specimen. However, off-the-shelf objectives, such as water- and oil-immersion objectives, have very limited working distances and exhibit resolution and aberration issues. Specialized objectives have been developed with improved working distances and resolution. However, these specialized systems increase costs and are highly sensitive to alignment and movement.

Thus, a more robust and efficient light sheet microscopy system is provided in the embodiments described below.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is an optical schematic diagram of a system for remote focusing all-optical light sheet microscopy, in accordance with various embodiments;

FIG. 2A is a cross-sectional side view of the specimen, sample chamber, and detection objective, in accordance with various embodiments;

FIG. 2B is a cross-sectional side view of the system of FIG. 2A, including an illumination source;

FIG. 3 is a cross-sectional side view of the specimen, sample chamber, and detection objective with a single light sheet plane, in accordance with various embodiments;

FIG. 4A is a flow diagram of a method for remote focusing all-optical light sheet microscopy, in accordance with various embodiments;

FIG. 4B is a flow diagram of a method for remote focusing in-plane scattering, in accordance with various embodiments; and

FIG. 5 is a schematic block diagram of computer hardware for a microscope controller, in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Typically, in light-sheet microscopy, when the specimen is moved for optical sectioning, the light sheet and detection objective can remain stationary. This leaves intact the critical alignment achieved between the light sheet and the focal plane of the detection objective. However, the movement of fragile specimens can cause damage to occur to the specimens. Furthermore, movement of the specimen may cause a change in the orientation of the specimen relative to the sample chamber in which the specimen is suspended. These concerns limit the speed with which the optical sectioning may be completed when the specimen is moved.

Alternatively, to avoid specimen movement, the light sheet, in tandem with the focal plane of the detection objective, may be moved through a stationary specimen. The light sheet may then be scanned through the specimen, synchronized with the movement of the detection objective, to illuminate the focal plane of the detection objective accordingly. However, it is difficult to maintain the precise alignment needed between the detection objective and the light sheet. The speed with which images can be captured may also be limited by the inertia of the detection objective. Furthermore, rapid movement of the detection objective or light sheet assemblies can cause vibration of the specimen and sample chamber. In some cases where immersion lenses are used, the vibration may travel through the immersion media.

Furthermore, each of these approaches assumes that the specimen will exhibit a uniform refractive index through any given section of the specimen. Even where the specimen has been cleared, this is not the case. A specimen may exhibit different structural variations through a given section of the specimen. Each of the features and structural variations within a sample may have a different index of refraction from the surrounding tissue. Thus, the focal plane of the detection objective and light sheet plane do not always coincide through the entirety of a section. Accordingly, this causes parts of the imaged section to be out of focus or the focal plane to not be illuminated by the light sheet.

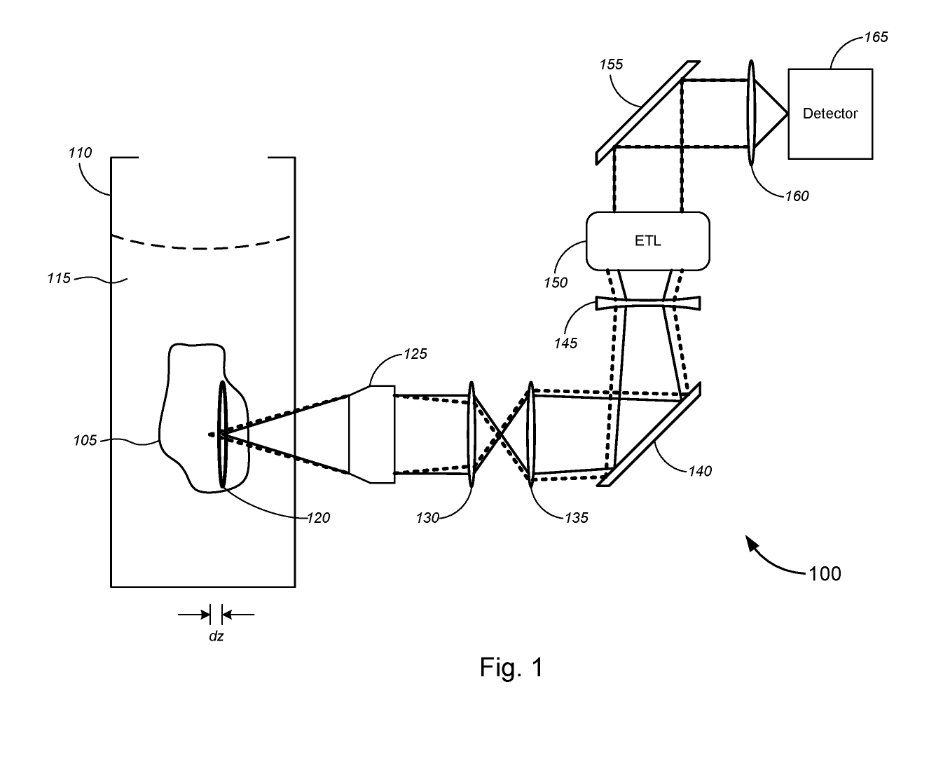

FIG. 1 illustrates an optical schematic for a remote focusing all-optical light sheet microscopy system 100. The system 100 includes a specimen 105 suspended in a sample chamber 110 in index matching medium 115, having a light sheet 120 illuminating a section to be imaged by the system 100. The system further includes a detection objective 125, tube lens 130, relay lens 135, mirror 140, offset lens 145, electro-tunable lens (ETL) 150, a second mirror 155, relay lens 160, and detector 165. In various embodiments, the some or all of the above elements may be placed on one or more movable stages, while in other embodiments, some or all of the elements may be fixed or stationary.

According to various embodiments, the specimen 105 may be cleared and labeled with fluorescent stains that, when illuminated by light sheet 120, cause the illuminated section to fluoresce. The specimen may be suspended in an index matching medium 115, where the index matching medium 115 has an index of refraction matching that of the cleared specimen 105. In some sets of embodiments, the cleared specimen and index-matching medium may have a high refractive index. In some embodiments, the index of refraction may be equal to or higher than the refractive index of water. For example, in one set of embodiments, the index matching medium may have an index of refraction (n) of approximately 1.4. In various embodiments, the index matching medium 115 may be a liquid or a gel that sets with the specimen 105 suspended inside. The sample chamber 110 may similarly be constructed from materials with an index of refraction matching or close to the index of refraction of the specimen 105, or index matching medium 115. For example, in some embodiments, the sample chamber 110 may be constructed with quartz windows through which the specimen may be imaged. In other embodiments, other materials may be utilized, such as, without limitation, glass or plastic.

During optical sectioning, the light sheet 120 may be scanned, along a detection axis, through the specimen 105. Thus multiple sections must be imaged, along the detection axis, to create a stack of sectional images from which a three-dimensional image of the specimen 105 may be constructed. Thus, the detection axis of the detection objective 125 is orthogonal to the light sheet 120 plane. In various embodiments, the light sheet 120 may be created in any manner known to those having skill in the art. For example, the light sheet 120 may be created utilizing, without limitation, any of single-plane illumination microscopy (SPIM), digital scanning light sheet microscopy (DSLM), orthogonal plane fluorescence optical sectioning (OPFOS), or other techniques known to those of ordinary skill in the art. In embodiments utilizing DSLM, the light sheet 120 may be generated and moved via a scanning mirror. (Although this disclosure refers to a scanning mirror as the device that positions a light sheet to illuminate a section for imaging, the skilled reader should appreciate that various embodiments can accommodate independently-positioned light sheets created and/or positioned by any suitable device, including but not limited to scanning mirrors.) The scanning mirror may rapidly scan the excitation laser along a single axis, through projection optics, such as an illumination objective, to create the light sheet in the back focal plane of the illumination objective. In various embodiments, the same or an additional scanning mirror may similarly scan the light sheet through the specimen 105 along the detection axis. In this manner, a system utilizing DSLM may be able to scan the light sheet through the specimen 105 without needing to move the projection optics generating the light sheet. In various embodiments, the projection optics may include an illumination objective as well.

In various embodiments, the detection objective 125 may include any of air or immersion type objectives. In some sets of embodiments, the detection objective 125 may be an air type objective having a long working distance, capable of imaging the entire depth of the specimen 105 within sample chamber 110. In other embodiments, all or part of the detection objective 125, sample chamber 110, and projection optics may be immersed in the index matching medium 115.

The detection objective 125 may, in various embodiments, be an infinity corrected lens. As such, the effective tube length of the detection objective 125 may be determined as a function of the focal length of the tube lens 130. A set of relay lenses 135, 160 may then be utilized to extend the length of the optical tube to accommodate the additional space needed by offset lens 145 and electro-tunable lens 150, as well as to invert the image generated by the combined detection objective 125 and tube lens 130 when it reaches detector 165. Two mirrors 140, 155 are provided to redirect the detected light as it travels through system 100. Thus, the detection objective 125, in combination with the tube lens 130 and relay lenses 135, 160 are used to project the image onto detector 165. It will be appreciated by those having skill in the art that more or less mirrors may be utilized in the optical system as needed.

In various embodiments, the ETL 150 may be an electrically tunable lens, in which the focal length of the ETL 150 may be adjusted over a wide range, as a function of supplied current. Thus, in various embodiments, a separate driver for ETL 150 may be provided, in communication with a microscope controller, to adjust the amount of current supplied to the ETL 150. In one set of embodiments, the ETL 150 may be a liquid lens, and hence mounted in a horizontal orientation. The mirrors 140, 155, may then be used to maneuver the detected light vertically through the ETL 150. In various embodiments, an offset lens may further be provided to extend the range of focal lengths over which the ETL 150 may be tuned. (While this disclosure uses the term “electro-tunable lens” to describe the function of the remote-focusing element in the disclosed system, it should be understood that embodiments are not limited to the use of the specific ETLs described herein, and that any remote-focusing element can be used in accordance with various embodiments, so long as it fulfills the functions required by the described embodiment. Other examples of remote-focusing elements can include, without limitation, oil/water lenses tunable with a voltage (electrowetting lenses) and acoustic focusing lenses.)

According to one set of embodiments, the ETL 150 may be positioned between the two relay lenses 135, 160 in a conjugate of the back focal plane of the combination of the detection objective 125 and tube lens 130. When placed in this position, the position of the imaged plane of the specimen 105 may be displaced as a function of the focal length of the ETL 150.

In various embodiments, the detector 165 may include any of a digital camera or imaging sensor. Imaging sensors may include, without limitation, a charge-coupled device (CCD) sensor, active-pixel sensor (APS) such as a complementary metal-oxide-semiconductor (CMOS) sensor, N-type metal oxide semiconductor (NMOS) sensor, analog alternatives, chemical alternatives such as film, or other suitable means for capturing images of the illuminated section of the specimen 105.

According to various sets of embodiments, the specimen 105 may exhibit spatial inhomogeneous scattering and absorption within its tissues and other structures. This results in a non-uniform index of refraction in the specimen 105. For example, a section of cleared tissue of specimen 105 may have a first index of refraction, while other cleared structures within the specimen 105 may have a second index of refraction different from surrounding cleared tissue. Accordingly, the light sheet 120 may experience variations in in-plane scattering and absorption as it travels through the specimen 105. In some cases, this may result in the curving and deformation of the light sheet 120, or other changes. The internal changes in the index of refraction of the specimen 105 cause the imaged plane to differ from the illuminated plane (as shown by the different focal points of the dashed lines and the solid lines in FIG. 1, with a distance 4, as illustrated by FIG. 1). Thus, the imaged plane corresponds to the changes in the focal plane of the detection objective 125, as caused by the changes in index of refraction of the specimen 105. This results in the blurring and loss of focus in the imaged optical section of the specimen 105.

Accordingly, in various embodiments, the ETL 150 may be utilized to correct for these internal variations in refractive index of the specimen 105. The focal plane of the detection objective 125 may be adjusted remotely by electrically adjusting the focal length of the ETL 150, corresponding to the internal changes in the index of refraction of the specimen 105 (as shown by the alignment of the dashed and solid lines between the ETL 150 and the mirror 155, and between the mirror 155 and the lens 160. Thus, in various embodiments, the out-of-focus features in each optical section may be focused by making adjustments via the ETL 150. In this manner, multiple images of an optical section may be captured at each adjusted focal plane. In some embodiments, the multiple images of the optical section may be combined to create a composite image of the optical section focused throughout the section.

Furthermore, by utilizing the ETL 150, the need to move the specimen 105, detection objective 125, or projection optics is eliminated. In embodiments where DSLM is utilized, the light sheet may be scanned along the detection axis while an illumination objective may remain stationary. Thus, the illumination side of the optical system 100 may already be stationary. Likewise, the detection objective 125 no longer needs to be moved in synchronization with the light sheet 120. Rather, the ETL 150 may be used to remotely adjust the focal plane of the detection objective 125 to track and synchronize with the movement of the light sheet 120.

In one set of embodiments, the ETL 150 may further include a driver in communication with a microscope controller. In some embodiments, the driver may be physically integrated into a housing of the ETL 150, while in other embodiments the driver may be a component located externally to the ETL 150 lens assembly. In various embodiments, the microscope controller may be dedicated hardware, or software executable on various hardware elements. For example, the microscope controller may include, without limitation, a personal computer, a network server, laptop computer, tablet, smart phone, an application specific integrated circuit (ASIC), a system on a chip (SOC), a field programmable gate array (FPGA), data acquisition (DAQ) system, or a combination of these devices. In various embodiments, the microscope controller may further be in communication with the detector 165. In some embodiments, the microscope controller may communicate with the ETL 150 and detector 165 through a direct wired or wireless connection. In other embodiments, the microscope controller may be in communication with the ETL 150 and detector 165 through either a wired or wireless communications network. According to some embodiments, the communications network might include a local area network (“LAN”), including without limitation a fiber network, or an Ethernet network; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks.

According to various embodiments, the microscope controller may control the focusing and image capturing operation of the system 100 in real-time, based on feedback from detector 165. For example, in one set of embodiments, the ETL 150 may be tuned to focal length such that the focal plane of the detection objective 125 coincides with an expected position of the illumination plane of light sheet 120. A first image may be captured of this focal plane at detector 165. In various embodiments, the microscope controller may then analyze the captured image of the section, or a live feed of the image on detector 165. The image of the section may then be utilized by the microscope controller to adjust the focal length of the ETL 150 to cause out-of-focus features to come into focus. In some embodiments, auto-focusing algorithms, as known to those having skill in the art, may be utilized to analyze the images and adjust the focal length of the ETL 150 in an automated manner. In other embodiments, the focal length of the ETL 150 may be adjusted manually via user input to the microscope controller. In a further set of embodiments, the focal length of the ETL 150 may be swept across a predetermined range of focal lengths to account for any expected shift of the illumination plane of the light sheet 120 and focal plane of detection objective 125 caused by the variable index of refraction. In some embodiments, the range of ETL 150 focal lengths to sweep may be adjusted dynamically after each section to narrow or expand the range of focal lengths through which the ETL 150 must be swept.

After the section has been captured, the light sheet 120 may be scanned to the next section to be imaged. Accordingly, in various embodiments, the focal length of the ETL 150 may then be adjusted by the microscope controller corresponding to an offset of the light sheet 120 between sections. The microscope controller may then capture multiple shots of the second section, as with the first imaged section. In some embodiments, the light sheet 120 may be scanned in a continuous manner along the detection axis. Thus, in some embodiments, the microscope controller may further utilize a focus tracking algorithm to adjust focal plane of detection objective 125 in real-time with illumination plane of the light sheet 120.

Thus, in contrast with conventional systems, the system 100 eliminates the need to move specimen 105 through an imaged plane, or the detection objective 125 and the projection optics of light sheet 120 through the specimen 105. Furthermore, unlike other remote focusing solutions, the current design allows for a fully focused optical section that accounts for in-plane inhomogeneity within the specimen 105.

In a further set of embodiments, the detection side elements, including the detection objective 125, tube lens 130, relay lenses 135, 160, mirrors 140, 155, offset lens 145, ETL 150, and detector 165, may all be mounted or positioned onto one or more movable stages. In some embodiments, detection side elements may be mounted on a single movable stage, such that the entire assembly may move in unison. In other embodiments, each of the elements, or combination of elements, may variously be placed on multiple movable stages that may be moved in unison so as to maintain alignment of the detection side of the system 100.

In some further sets of embodiments, illumination side elements, including an illumination objective and scanning mirror, for generating the light sheet may also be positioned on one or more movable stages. In some embodiments, each of the elements of the illumination side may be positioned on a single movable stage, while in other embodiments, individual elements or combinations of elements may variously be placed on multiple movable stages. Where multiple movable stages are utilized, the illumination side elements may be moved in unison so as to maintain alignment of the illumination side (not depicted) of the system 100.

In various embodiments, both the illumination side and detection side of the system 100 may be moved in unison with each other. In some embodiments, both the detection side and illumination side may be positioned on the same movable stage. Thus, while the illumination side and detection side of system 100 may be movable, the while allowing the sample chamber 110 to remain stationary and undisturbed by movement of the rest of the system 100.

Accordingly, in one set of embodiments, the specimen 105 may be too large to capture an entire optical section with detection objective 125, or may not be able to be recorded by the detector 165 as limited by the size of the imaging sensor at the magnification desired. Thus, the detection side and illumination side may be moved to capture adjacent areas in the same plane as a first captured sectional image. Thus, multiple in-plane images of the section may be stitched together to form a composite image of the section, effectively extending the field of view capable of being imaged at a single position by the detection objective 125 and/or detector 165.

In yet another set of embodiments, the wavelength of the light sheet 120 may be adjustable. The light sheet 120 may be generated by a wavelength tunable light source. In various embodiments, the wavelength of the light sheet 120 may be adjusted according the wavelength-dependent variations in refractive index of the specimen 105. In other embodiments, multiple fluorophores may be utilized within specimen 105 to label different tissues and structures. Accordingly, a combination of light sheet 120 wavelength adjustment and ETL 150 focal length adjustment may be utilized to capture optical sections of the specimen 105.

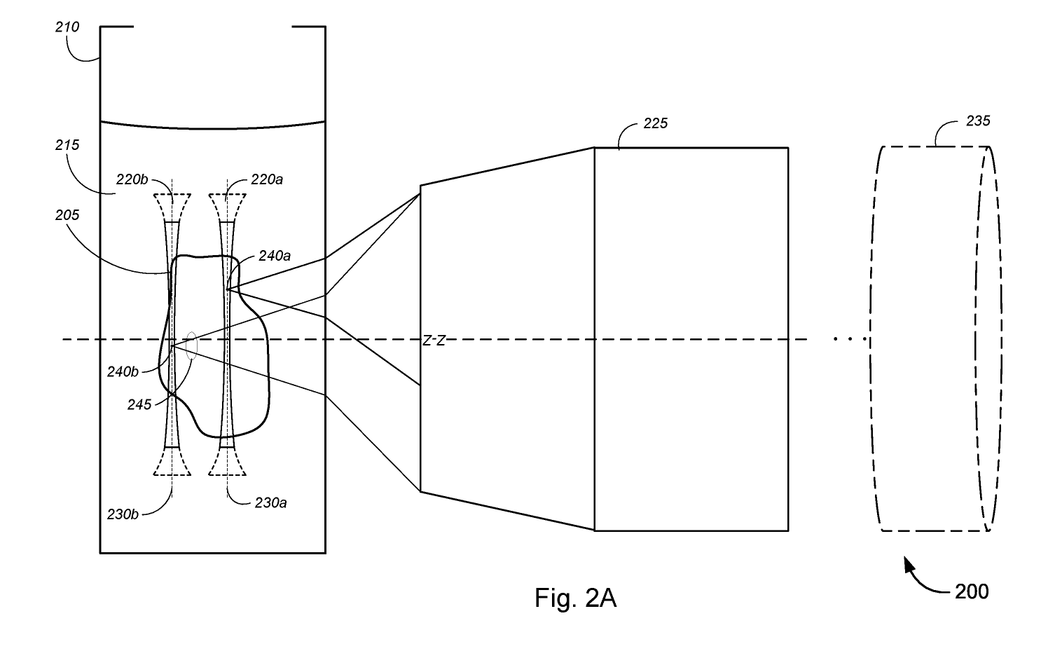

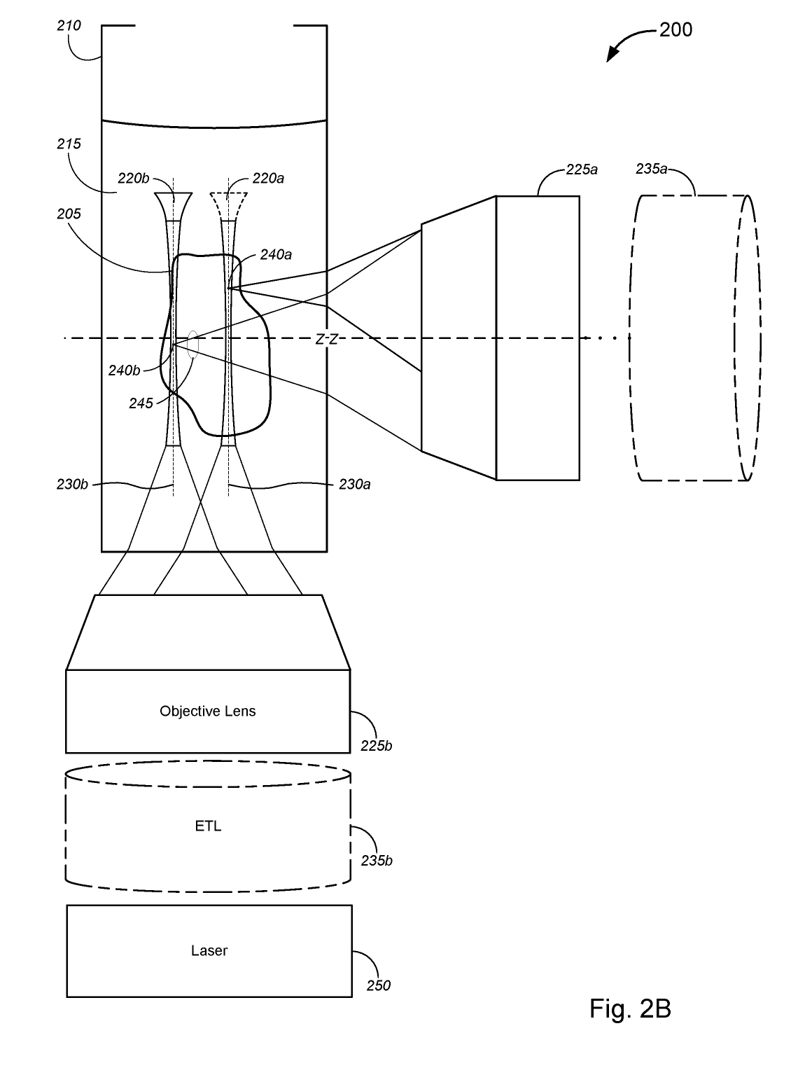

FIG. 2A illustrates a cross-sectional side view, along the detection axis Z-Z, of the detection side optics of the microscopy system 200, in accordance with various embodiments. The system 200 includes specimen 205 suspended within sample chamber 210 in index matching media 215. Light sheets 220a, 220b are provided corresponding to the illumination planes as the light sheet 220a is scanned along detection axis Z-Z to the position of light sheet 220b. The system 200 further includes detection objective 225, through which the detected light is projected to ETL 235.

As described with respect to FIG. 1, a light sheet 220a, 220b may be generated through the specimen 205, such that the illumination plane is orthogonal to the detection axis Z-Z. In various embodiments, assuming a uniform index of refraction within specimen 205, and between specimen 205 and index matching medium 215, the light sheet 220a, 220b may be scanned from an initial position within the specimen 205 to an end position, such that optical sections of the entire specimen 205 may be captured. In one set of embodiments, the light sheet 220a may be scanned from a front surface of the specimen, facing the detection objective 225, to the position depicted by light sheet 220a.

In various embodiments, the focal plane 230a of the detection objective 225 may be adjusted remotely, via ETL 235, to coincide with the illumination plane of light sheet 220a. As the light sheet 220a is scanned to the position of light sheet 220b, the focal plane 230a may be adjusted to the position depicted by focal plane 230b, by the ETL 235, to remain synchronized with the illumination plane of the light sheet 220b. A uniform refractive index is depicted across the section illuminated by the light sheet 220a, 220b, as well as between the specimen 205 and index matching medium 215.

However, in various other embodiments, a given section of the specimen 205 may exhibit inhomogeneous in-plane scattering and absorption characteristics as the light sheet 220a, 220b travels through the specimen 205. Accordingly, in one set of embodiments, for each light sheet 220a, 220b position, the focal length of the ETL 235 may be adjusted, via a microscope controller, for an expected position of the illuminated plane, as well as to focus on any out-of-focus features within the imaged section of specimen 205.

In another set of embodiments, mismatches between the refractive index of the specimen 205, index matching medium 215, and detection objective 225 may also cause a shift in the focal plane 230a, 230b of the detection objective 225. Cleared specimens 205 may exhibit subtle gradients and inhomogeneity in refractive index. This causes corresponding shifts in the focal plane of the detection objective 225 relative to the image depth within the specimen 205. These effects may also vary between different types of detection objectives 225, depending on their design with respect to numerical aperture, magnification, and working distance. Accordingly, in some embodiments, the focal length of the ETL 235 may be adjusted to account for a focal shift caused by variations in the refractive index of the specimen 205. Generally, in the design of detection objectives 225, longer working distances result in smaller numerical apertures, and smaller numerical apertures reduce the resolution of the detection objective. Longer working distances are also more prone to refractive index changes and mismatches, causing aberrations and blur. Thus, by being able to sweep a focal length of the ETL 235 to shift the focal plane of the detection objective 225, many of undesirable effects can be corrected for or avoided, without having to rely on a precise match between the detection objective 225 and specimen 205.

In various embodiments, auto-focusing algorithms may be utilized to adjust the focal length of the ETL 235 in an automated manner, so as to bring the various features in an imaged section into focus. In other embodiments, the focal length of the ETL 235 may be adjusted manually via user input to the microscope controller. In a further set of embodiments, the focal length of the ETL 235 may be swept across a predetermined range of focal lengths to account for any expected shift of the illumination plane of the light sheet 220a, 220b, and corresponding shift in the focal plane 230a, 230b of the detection objective 225.

According to a further set of embodiments, as the light sheet 220a is scanned to the position of light sheet 220b, the focal length of the ETL 235 may be adjusted, in real-time, by the microscope controller corresponding the location of the light sheet 220a, 220b. At each position of the light sheet 220a, 220b as it is scanned through the sample 205, the ETL 205 may adjust the focal plane 230a, 230b, of the detection objective 225 to focus on the out of focus features and structures within a each section and/or illumination plane of light sheet 220a, 220b at each position. For example, in some embodiments, a focal point 240a of focal plane 230a may coincide with the illumination plane of light sheet 220a. However, in one set of embodiments, when the light sheet 220a is scanned to the position of light sheet 220b, the specimen 205 may exhibit a structure 245 having a different index of refraction from the surrounding tissue. Accordingly, because the section illuminated by light sheet 220b must be imaged through structure 245, the focal plane 230b may not coincide with the illumination plane of light sheet 220b. Accordingly, focal point 240b may be out-of-focus or blurry where the surrounding tissue may be correctly imaged.

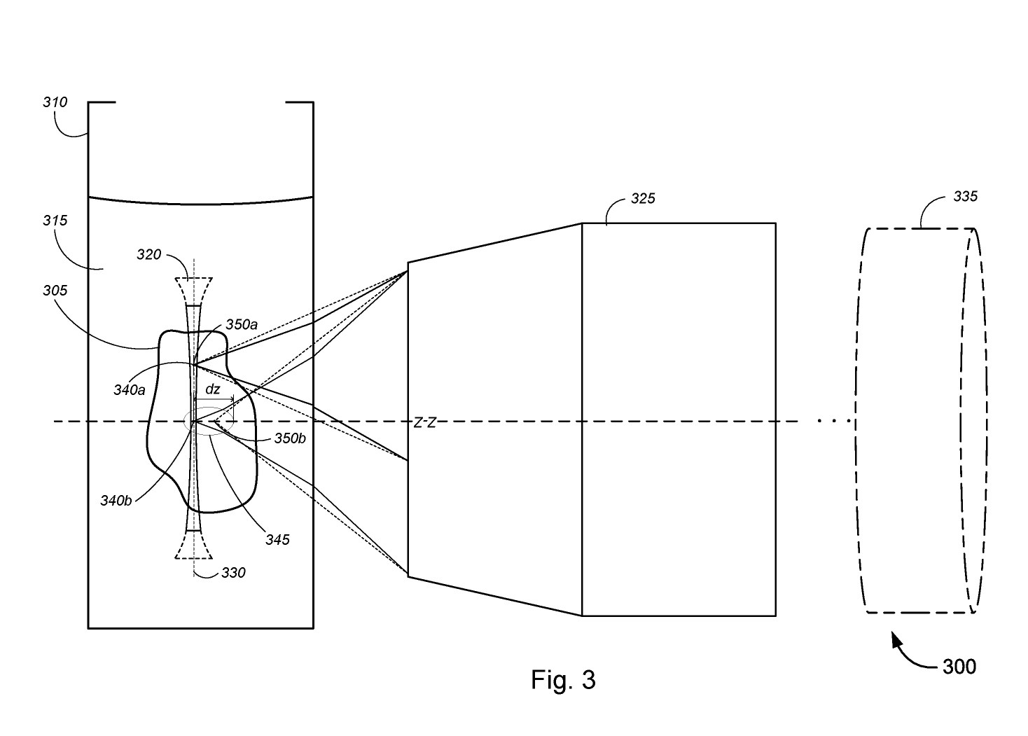

Thus, to focus on focal point 240b, the focal length of the ETL 235 may need to be adjusted, reduced for lower refractive index and increased for higher refractive index, to cause a corresponding shift in the focal plane 230b. In this manner, the ETL 235 may adjust the focal plane 230b to coincide with the illumination plane of light sheet 220b at the position of the focal point 240b. A similar procedure may be followed to adjust the focal plane 230a, 230b to correct for in-plane scattering and absorption variations, as described in more detail below with respect to FIG. 3.

In some embodiments, the system might employ an ETL on the illumination side of the system, to process the light source, in addition to (or as an alternative to) employing an ETL on the detection side. For example, FIG. 2B illustrates the system 200 of FIG. 2A, with the same detection objective 225a and ETL 235a, but with the addition of a second, illumination objective 225b and ETL 235b positioned in the light path between a light source (e.g., the laser 250) and the sample 205. This enhancement can provide multiple benefits. The illumination-side ETL 235b can be used to ensure that the light sheet provide homogenous and/or even illumination across the sections of the sample to be imaged.

First, through the use of the ETL 235b, the laser 250 can be refocused so that the thinnest part of the light sheet 230 coincides with the focal point 240 of the detection optics, allowing for optimal imaging. For example, as noted above, the sample 205 might have a different refractive index than the medium 215, and/or the sample 205 might have inhomogeneous structures, changing the refractive index within the sample 205 itself. In addition to causing focusing issues on the detection side, these same phenomena can cause uneven illumination of the imaged portion of the sample. Using similar procedures to those described above and below with regard to focusing the detection optics, the ETL 235b can be used to refocus the light sheet 230 to correct for such illumination issues. Moreover, the ETL 235b on the illumination side of the system can be used to oscillate the focus (thinnest) point of the light sheet 230 while the detection optics remain constant, allowing improved gain in the detection, and an enhanced signal to noise ratio (SNR) in the resulting imagery.

Further, the use of an ETL 235b on the illumination side obviates the need for any movement of the sample 205 or any components of the system 205 to change the position of the light sheet 230 itself (e.g., between light sheet 230a and light sheet 230b). This prevents any vibration that could disturb fragile samples and also eliminates another source of focus error in the detection process. For example, by using an ETL 235 in both the detection side and the illumination side of the system, the system 200 of FIG. 2B can eliminate the need for movement of any objectives 225, and in fact, the need for any movable stages at all, decreasing configurational and operational complexity of the system 200 as compared with conventional systems, in which the illumination stage and/or the sample would have to be physically moved to correspond to different focal planes of the detection stage.

FIG. 3 illustrates a cross-sectional side view, along the detection axis Z-Z, of the detection side optics of the microscopy system 300, in accordance with various embodiments. The system 300 includes specimen 305 suspended within sample chamber 310 in index matching media 315. The light sheet 320 is provided corresponding to an illumination plane. The light sheet 320 is scanned along detection axis Z-Z, through sample 305 (either through mechanical scanning or by using an ETL as described above with respect to FIG. 2B). The system 300 further includes detection objective 325, through which the detected light is projected to ETL 335. In various embodiments, the specimen 305 may further include a structure 345 having an index of refraction different from the surrounding tissue of specimen 305. For example, the structure 345 may include, without limitation, various cellular and biological structures, pockets of air or fluid, or other structures that may occur within the specimen 305.

In various embodiments, the light sheet 320 may illuminate a plane within the specimen 305 including parts of the structure 345. Therefore, as discussed above, structure 345 may exhibit in-plane scattering properties different from its surrounding tissue. Accordingly, the focal plane 330 of the detection objective 325 may be adjusted to coincide with the illumination plane of light sheet 320. Thus, in various embodiments, focal point 350a may coincide with the illuminated point 340a. However, illuminated point 340b may reside within structure 345. Accordingly, the imaged plane will differ from the illumination plane when the focal plane 330 of the detection objective 325 is aligned with the illumination plane at focal point 350a. For example, where structure 345 has a higher index of refraction than the surrounding tissue, the focal point 350b will be displaced by a function of the index of refraction of the structure 345 and length of the structure 345 along the detection axis indicated as “dz.” The focal length of the ETL 335 may be adjusted accordingly to shift the focal plane 330 of the detection objective 325 such that focal point 350b coincides with illuminated point 340b, thus bringing illuminated point 340b into focus. In a similar manner, the focal point of the illumination plane 330 can be moved using a similar ETL on the illumination side, as described above with regard to FIG. 2B.

In further sets of embodiments, multiple images may be taken in this manner for each section of the specimen 305. Thus, each sectional image of the specimen 305 may itself be a composite image having corrected focus for all of the features in the section. As discussed above, with respect to FIGS. 1 & 2A, various focusing algorithms may be implemented to adjust the focal length of the ETL 335 (and/or the focal length of a corresponding ETL on the illumination side, as shown in FIG. 2B), including, without limitation, utilizing auto-focusing techniques, manual adjustment via user input to a microscope controller, or performing a sweep of electrical current supplied to the ETL 335 corresponding to a predetermined range of focal lengths of the ETL 335 to account for any expected shift of the illumination plane of the light sheet 320 and focal plane of detection objective 330 caused by the in-plane changes in refractive index like with structure 345.

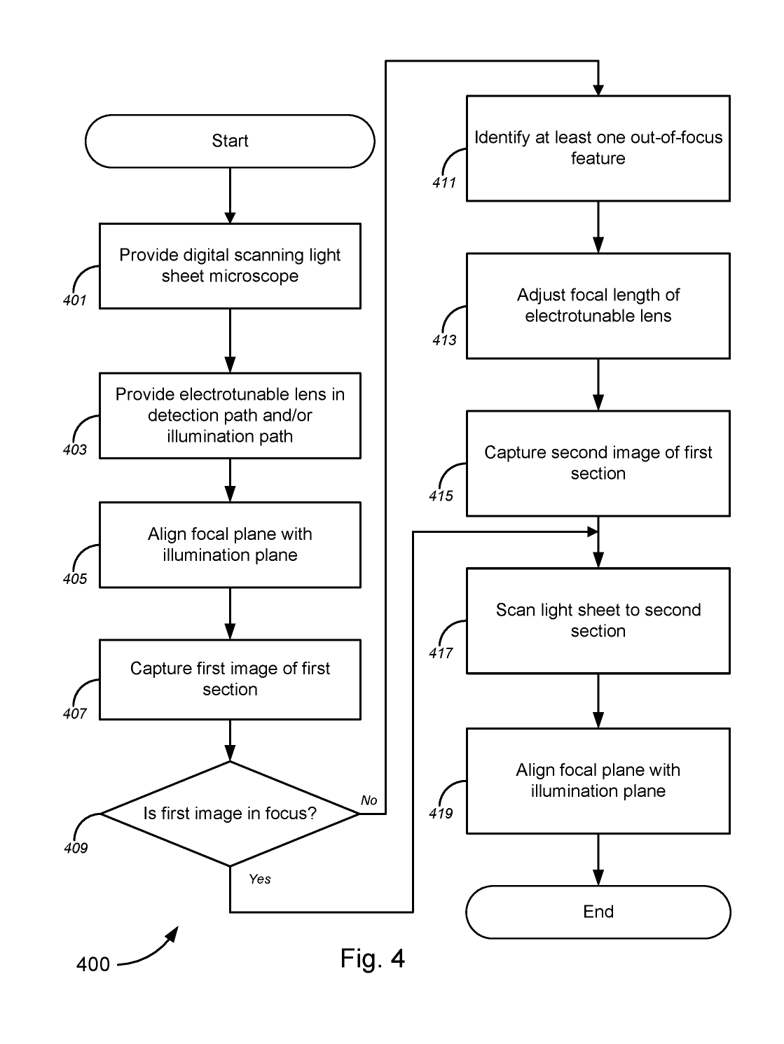

FIG. 4 is a flow diagram of a method 400 for remote focusing an all-optical light sheet microscopy system, in accordance with various embodiments. The method 400 begins, at block 401, by providing a digital scanning light sheet microscope. As discussed above, with respect to FIG. 1, the digital scanning light sheet microscope may include, without limitation, illumination side optics for generating a digital scanning light sheet having at least a scanning mirror, a sample chamber holding a specimen suspended in an index matching medium, a detection objective, tube lens, relay lens, mirrors, and a detector.

At block 403, an ETL may be provided in the detection path and/or the illumination path of the digital scanning light sheet microscope. In various embodiments, the ETL 150 may be positioned between the two relay lenses corresponding to a conjugate of the back focal plane of the detection objective and tube lens combination. When placed in this position, the position of the imaged plane of the specimen may be displaced as a function of the focal length of the ETL. Put another way, the focal plane of the detection objective may be adjusted as a function of the focal length of the ETL. In like manner, the focal plane of an illumination objective can be adjusted as a function of the focal length of an illumination ETL. In some set of embodiments, an offset lens may further be provided extend the range of focal lengths over which the ETL may be tuned. In further sets of embodiments, a microscope controller may be provided in communication with ETL and detector. In some embodiments, the microscope controller may further be in communication with the scanning mirror generating the light sheet.

Accordingly, in various embodiments, the scanning mirror may project a light sheet on a section of the sample desired to be imaged. At block 405, the focal plane of the detection objective may then be aligned to the illumination plane of the light sheet. In various embodiments, the initial alignment may be achieved by manual alignment of the detection objective relative to the position of the light sheet. This may include alignment of the focal plane of the detection objective to coincide with the illumination plane of the light sheet. The alignment may further include positioning of the detection objective such that the detection axis of the detection objective is orthogonal to the illumination plane of the light sheet. In some embodiments, precise manual adjustment of the focal plane of the detection objective may not be necessary, and may be adjusted by the ETL after approximate positioning of the detection objective such that the focal plane and illumination plane are within a distance capable of being aligned by adjustments within the tunable focal length range of the ETL.

At block 407, a first image of the first section may be captured by the detector after alignment. In various embodiments, the focal plane may be aligned to coincide with an expected illumination plane, assuming a uniform refractive index of a sample. Thus, a focal plane may be positioned such that most of the imaged plane coincides with the illuminated plane within the specimen. In some embodiments, the specimen may have a substantially uniform refractive index. In other embodiments, the specimen may exhibit significant variations in in-plane scattering and absorption resulting in an inhomogeneous index of refraction. Thus, in various embodiments, the detector may then capture an image, or provide a feed of the live image to the microscope controller.

At decision block 409, the microscope controller may then determine whether the first section is in focus. In various embodiments, the microscope controller may analyze the captured image or live image feed from the detector to confirm image focus for various parts of the image. In some embodiments, the captured image or live image feed may be divided into a grid or otherwise separated into a plurality of different focus areas. In various embodiments, the microscope controller may then determine whether or not the focus of the image is within a tolerance range by, without limitation, determining that a threshold percentage of the image has a focus level within the tolerance range, each of the plurality of focus areas of the entire image has a focus level within the tolerance range, or combination of both.

If the microscope controller determines that the image is within a focus tolerance range, at block 417, the light sheet may be scanned to a second section. If the image is not in focus, at block 411, the microscope controller may identify at least one out of focus feature in the image. In various embodiments, the out of focus feature may correspond to one or more of the plurality of different focus areas analyzed in the first image. In some embodiments, the out of focus feature may indicate the presence of one or more structures within the specimen causing in-plane variations in refractive index within the sample.

At block 413, the microscope controller may adjust the focal length of the ETL to focus on at least one selected out of focus feature. In various embodiments, the microscope controller may, based on the captured first image, determine the appropriate adjustment to the focal length of the ETL necessary to bring the out of focus feature into focus. In other embodiments, the microscope controller may auto-focus the out of focus feature. In various embodiments, the microscope controller may utilize the live image feed to determine when the out of focus feature has been brought into focus during autofocusing. Thus, the live image feed may be continually monitored and the focus continually analyzed by the microscope controller. In another set of embodiments, the microscope controller may allow a user to manually adjust the focal length of the ETL until the out of focus feature is in focus. In these embodiments, the microscope controller, detector, or both may be coupled to a display through which a user may monitor the focus of the image. In yet another set of embodiments, the microscope controller may sweep the focal length of the ETL over a predetermined range of values. In various embodiments, the predetermined range of values may be entered based on expected values, known initial conditions of the system, or dynamically modified based on measured values at which the out of focus features are correctly focused.

At block 415, the focused-adjusted second image of the first section may be captured. In various embodiments, the second image may focus on the at least one out of focus feature having a refractive index different from the surrounding tissue. Thus, in various embodiments, the first image may be combined with the second image to form a composite image of the section with both the structure and surrounding tissue in focus. In some further sets of embodiments, the focusing procedure may be repeated on the first section to capture additional out-of-focus features. Thus, in various further embodiments, the, more than two images may be captured for a given section.

At block 417, with at least two images of the section captured, the light sheet may be scanned into position to image a second section of the specimen. In various embodiments, the second section may be a fixed step away from the first section, corresponding to a three-dimensional resolution desired along the optical axis. In other embodiments, the light sheet may be continuously scanned.

At block 419, the focal plane of the detection objective may be aligned with the illumination plane. In various embodiments, keeping both the sample chamber and detection objectives stationary, the focal length of the ETL may be adjusted, corresponding to a displacement of the light sheet illumination plane. Thus, as with the first section, according to some sets of embodiments, the focal plane may be aligned to coincide with an expected illumination plane, assuming a uniform refractive index through the second section of the sample. From this point, a first image of the second section may be captured, and focusing procedures described above, with respect to the first section, may be applied to the second section. In various embodiments, this procedure may be repeated for each section until the entire specimen has been optically sectioned.

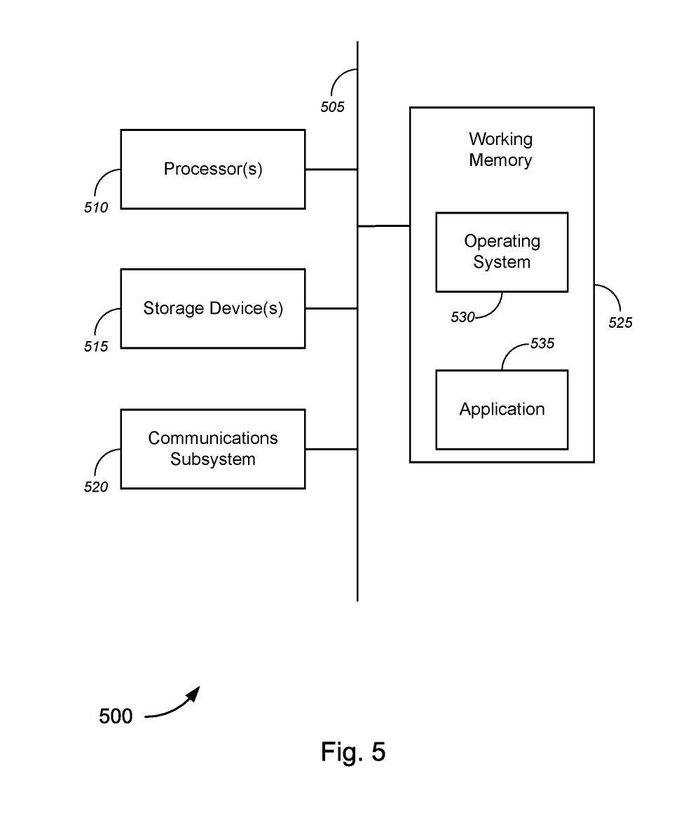

FIG. 5 is a schematic block diagram of a computer architecture for a microscope controller, in accordance with various embodiments. FIG. 5 provides a schematic illustration of one embodiment of a computer system 500 that can perform the methods provided by various other embodiments, as described herein, and/or can perform the functions of the hardware management controller, hardware management robot, or any other computer systems as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or integrated manner.

The computer system 500 includes a plurality of hardware elements that can be electrically coupled via a bus 505 (or may otherwise be in communication, as appropriate). The hardware elements may include one or more processors 510, including, without limitation, one or more general-purpose processors and/or one or more special-purpose processors (such as digital signal processing chips, graphics acceleration processors, and/or the like). In general, embodiments can employ as a processor any device, or combination of devices, that can operate to execute instructions to perform functions as described herein. Merely by way of example, and without limitation, any microprocessor (also sometimes referred to as a central processing unit, or “CPU”) can be used as a processor, including without limitation one or more complex instruction set computing (“CISC”) microprocessors, such as the single core and multicore processors available from Intel Corporation™ and others, such as Intel's X86 platform, including, e.g., the Pentium™, Core™, and Xeon™ lines of processors. Additionally and/or alternatively, reduced instruction set computing (“RISC”) microprocessors, such as the IBM Power™ line of processors, processors employing chip designs by ARM Holdings™, and others can be used in many embodiments. In further embodiments, a processor might be a microcontroller, embedded processor, embedded system, ASIC, SOC, or the like.

As used herein, the term “processor” can mean a single processor or processor core (of any type) or a plurality of processors or processor cores (again, of any type) operating individually or in concert. Merely by way of example, the computer system 500 might include a general-purpose processor having multiple cores, a digital signal processor, and a graphics acceleration processor. In other cases, the computer system might 500 might include a CPU for general purpose tasks and one or more embedded systems or microcontrollers, for example, to run real-time functions. The functionality described herein can be allocated among the various processors or processor cores as needed for specific implementations. Thus, it should be noted that, while various examples of processors 510 have been described herein for illustrative purposes, these examples should not be considered limiting.

The computer system 500 may further include, or be in communication with, one or more storage devices 515. The one or more storage devices 515 can comprise, without limitation, local and/or network accessible storage, or can include, without limitation, a disk drive, a drive array, an optical storage device, a solid-state drive, flash-based storage, or other solid-state storage device. The solid-state storage device can include, but is not limited to, one or more of a random access memory (“RAM”) or a read-only memory (“ROM”), which can be programmable, flash-updateable, or the like. Such storage devices may be configured to implement any appropriate data stores, including, without limitation, various file systems, database structures, or the like.

The computer system 500 might also include a communications subsystem 520, which can include, without limitation, a modem, a network card (wireless or wired), a wireless programmable radio, or a wireless communication device. Wireless communication devices may further include, without limitation, a Bluetooth device, an 802.11 device, a WiFi device, a WiMax device, a WWAN device, cellular communication facilities, or the like. The communications subsystem 520 may permit data to be exchanged with a customer premises, residential gateway, authentication server, a customer facing cloud server, network orchestrator, host machine servers, other network elements, or combination of the above devices, as described above. Communications subsystem 520 may also permit data to be exchanged with other computer systems, and/or with any other devices described herein, or with any combination of network, systems, and devices. According to some embodiments, the network might include a local area network (“LAN”), including without limitation a fiber network, or an Ethernet network; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth protocol, or any other wireless protocol; or any combination of these or other networks.

In many embodiments, the computer system 500 will further comprise a working memory 525, which can include a RAM or ROM device, as described above. The computer system 500 also may comprise software elements, shown as being currently located within the working memory 525, including an operating system 530, device drivers, executable libraries, and/or other code. The software elements may include one or more application programs 535, which may comprise computer programs provided by various embodiments, and/or may be designed to implement methods and/or configure systems provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 500) to perform methods in accordance with various embodiments of the invention. According to a set of embodiments, some or all of the procedures of such methods are performed by the computer system 500 in response to processor 510 executing one or more sequences of one or more instructions (which might be incorporated into the operating system 530 and/or other code, such as an application program 535) contained in the working memory 525. Such instructions may be read into the working memory 525 from another computer readable medium, such as one or more of the storage device(s) 515. Merely by way of example, execution of the sequences of instructions contained in the working memory 525 might cause the processor(s) 510 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 500, various computer readable media might be involved in providing instructions/code to processor(s) 510 for execution and/or might be used to store and/or carry such instructions/code (e.g., as signals). In many implementations, a computer readable medium is a non-transitory, physical and/or tangible storage medium. In some embodiments, a computer readable medium may take many forms, including but not limited to, non-volatile media, volatile media, or the like. Non-volatile media includes, for example, optical and/or magnetic disks, such as the storage device(s) 515. Volatile media includes, without limitation, dynamic memory, such as the working memory 525.

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 520 (and/or components thereof) generally will receive the signals, and the bus 505 then might carry the signals (and/or the data, instructions, etc. carried by the signals) to the processor(s) 510, or working memory 525, from which the processor(s) 510 retrieves and executes the instructions. The instructions received by the working memory 525 may optionally be stored on a storage device 515 either before or after execution by the processor(s) 510.

According to a set of embodiments, the computer system 500 may be a joint use utility manager having access to, and in communication with, one or more joint use utility clients running on one or more end devices respectively, a device or system associated with a joint use utility owner, smart attachment on a joint use utility, a joint use utility database, and location server. In various embodiments, each of the one or more end devices, an end device of a joint use owner, location server, or smart attachment may themselves include one or more hardware elements similar to computer system 500.

According to various sets of embodiments, the computer system 500 may include computer readable media, having stored thereon a plurality of instructions, which, when executed by the processor 510, allows the computer system 500 to perform functions in accordance with the various embodiments described above.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture, but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A remote focusing all-optical digital scanning light sheet microscopy system comprising:
an all-optical digital scanning light sheet microscope having at least:
illumination side optics generating a light sheet,
a detection objective aligned having a detection axis substantially orthogonal to the light sheet, and
image detector having an imaging sensor for recording images captured by the detection objective;
an electro-tunable lens positioned in a detection path of the detection objective, wherein a focal length of the electro-tunable lens is adjustable electrically as a function of electrical current supplied by a driver;
a microscope controller communicatively coupled with the electro-tunable lens, the image detector, and the scanning mirror, the microscope controller comprising:
at least one processor;
non-transitory computer readable media having encoded thereon computer software comprising a set of instructions executable by the at least one processor to:
align, via the electro-tunable lens, a focal plane of the detection objective to an expected position of an illumination plane of the light sheet, the light sheet illuminating a first section of a specimen;
capture, via the image detector, a first image of the first section detected by the detection objective;
determine whether the first image of the first section is within a focus tolerance range, wherein the focus tolerance range specifies threshold focus levels for a captured image;
identify at least one out-of-focus feature in the first image of the first section;
adjust, via the driver of the electro-tunable lens, the focal length of the electro-tunable lens, wherein the focal plane of the detection objective is shifted to coincide with the position of the illumination plane of the light sheet at the at least one out-of-focus feature; and
capture a second image of the first section having the at least one out-of-focus feature in focus.

2. The system of claim 1, wherein the set of instructions are further executable by the at least one processor to monitor, via the image detector, a live feed of a detected image of the specimen, the detected image corresponding, in real-time, to a position of the focal plane of the detection objective.

3. The system of claim 2, wherein the set of instructions are further executable by the at least one processor to autofocus on the out-of-focus feature, based on feedback from the live feed of the detected image, wherein the adjustments to the focal length of the electro-tunable lens are controlled according to the feedback form the live feed of the detected image.

4. The system of claim 1, wherein the set of instructions are further executable by the at least one processor to sweep, via the driver of the electro-tunable lens, the focal length of the electro-tunable lens over a predetermined range of focal lengths, wherein the predetermined range is based on expected shift of the illumination plane within the first section of the sample.

5. The system of claim 1, wherein the set of instructions are further executable by the at least one processor to:
identify, based on the first image, a corrective shift in the focal plane required to focus the at least one out-of-focus feature; and
wherein the focal length of the electro-tunable lens is adjusted according to the corrective shift required to focus the at least one out-of-focus feature.

6. The system of claim 1, wherein the set of instructions are further executable by the at least one processor to:
divide the first image of the first section into a grid having a plurality of focus areas, wherein focus levels are determined for each focus area of the plurality of focus areas, wherein focus levels for each focus area are compared to the threshold focus level; and
wherein the at least on out-of-focus feature is identified within one or more of the plurality of focus areas having respective focus levels below the threshold focus level.

7. The system of claim 1, wherein the illumination side optics include a scanning mirror, and wherein the set of instructions are further executable by the at least one processor to:
scan, via the scanning mirror, the light sheet to a position wherein the illumination plane of the light sheet illuminates a second section of the specimen;
capture, via the image detector, a first image of the second section detected by the detection objective;
determine whether the first image of the second section is within the focus tolerance range;
identify at least one out-of-focus feature in the first image of the second section;
adjust, via the driver of the electro-tunable lens, the focal length of the electro-tunable lens, wherein the focal plane of the detection objective is shifted to coincide with the position of the illumination plane of the light sheet at the at least one out-of-focus feature of the second section; and
capture a second image of the second section having the at least one out-of-focus feature of the second section in focus.

8. The system of claim 1, wherein the illumination side optics include a scanning mirror, and wherein the light sheet is scanned in a continuous motion by the scanning mirror.

9. The system of claim 1, wherein the illumination side optics include a scanning mirror, and wherein the light sheet is scanned by the scanning mirror in a stepped scan, wherein a step between the first and second sections corresponds to a three dimensional resolution to be provided by the section images along a detection axis of the detection objective.

10. The system of claim 1, wherein the detection objective is an air objective.

11. The system of claim 1, wherein the all-optical digital scanning light sheet microscope and the electro-tunable lens are positioned on one or more movable stages, wherein the set of instructions are further executable by the at least one processor to:
move, in-plane with the first section, the one or more movable stages in position to capture a first extended field of view image of the first section outside of a field of view presented by the first image of the first section;
capture the first extended field of view image of the first section;
determine whether the first extended field of view image of the first section is within the focus tolerance range;
identify at least one out-of-focus feature in the first extended field of view image of the first section;
adjust, via the driver of the electro-tunable lens, the focal length of the electro-tunable lens, wherein the focal plane of the detection objective is shifted to coincide with the position of the illumination plane of the light sheet at the at least one out-of-focus feature in the first extended field of view image of the first section; and
capture a second extended field of view image of the first section having in focus the at least one out-of-focus feature in the first extended field of view image of the first section.

12. The system of claim 1, wherein the illumination side optics include a wavelength tunable laser, and wherein the set of instructions are further executable by the at least one processor to adjust a wavelength of the light sheet.

13. The system of claim 1, wherein the illumination side optics include a second electro-tunable lens to adjust a focal plane of the light sheet to provide homogenous lighting of the first section of the specimen.

14. The system of claim 1, wherein the set of instructions is further executable to control the second electro-tunable laser to scan the light sheet.

15. A microscope controller for a remote focusing all-optical digital scanning light sheet microscopy system, the microscope controller in communication with an electro-tunable lens, image detector, the microscope controller comprising:
at least one processor;
non-transitory computer readable media having encoded thereon computer software comprising a set of instructions executable by the at least one processor to:
align, via the electro-tunable lens, a focal plane of a detection objective to an expected position of an illumination plane of a light sheet, the light sheet illuminating a first section of a specimen;
capture, via the image detector, a first image of the first section detected by the detection objective;
determine whether the first image of the first section is within a focus tolerance range, wherein the focus tolerance range specifies a threshold focus level for a captured image;
identify at least one out-of-focus feature in the first image of the first section;
adjust, via a driver of the electro-tunable lens, the focal length of the electro-tunable lens, wherein the focal plane of the detection objective is shifted to coincide with the position of the illumination plane of the light sheet at the at least one out-of-focus feature; and
capture a second image of the first section having the at least one out-of-focus feature in focus.

16. The microscope controller of claim 15, wherein the set of instructions are further executable by the at least one processor to:
monitor, via the image detector, a live feed of a detected image of the specimen, the detected image corresponding, in real-time, to a position of the focal plane of the detection objective; and
autofocus on the out-of-focus feature, based on feedback from the live feed of the detected image, wherein the adjustments to the focal length of the electro-tunable lens are controlled according to the feedback form the live feed of the detected image.

17. The microscope controller of claim 15, wherein the set of instructions are further executable by the at least one processor to sweep, via a driver of the electro-tunable lens, the focal length of the electro-tunable lens over a predetermined range of focal lengths, wherein the predetermined range is based on expected shift of the illumination plane within the first section of the sample.

18. The microscope controller of claim 15, wherein the set of instructions are further executable by the at least one processor to:
identify, based on the first image, a corrective shift in the focal plane required to focus the at least one out-of-focus feature; and
wherein the focal length of the electro-tunable lens is adjusted according to the corrective shift required to focus the at least one out-of-focus feature.

19. The microscope controller of claim 15, wherein the set of instructions are further executable by the at least one processor to:
divide the first image of the first section into a grid having a plurality of focus areas, wherein focus levels are determined for each focus area of the plurality of focus areas, wherein focus levels for each focus area are compared to the threshold focus level; and
wherein the at least on out-of-focus feature is identified within one or more of the plurality of focus areas having respective focus levels below the threshold focus level.

20. The microscope controller of claim 15, wherein the set of instructions are further executable by the at least one processor to:
scan, via a scanning mirror, the light sheet to a position wherein the illumination plane of the light sheet illuminates a second section of the specimen;
capture, via the image detector, a first image of the second section detected by the detection objective;
determine whether the first image of the second section is within the focus tolerance range;
identify at least one out-of-focus feature in the first image of the second section;
adjust, via the driver of the electro-tunable lens, the focal length of the electro-tunable lens, wherein the focal plane of the detection objective is shifted to coincide with the position of the illumination plane of the light sheet at the at least one out-of-focus feature of the second section; and
capture a second image of the second section having the at least one out-of-focus feature of the second section in focus.

21. A method for remote focusing all-optical digital scanning light sheet comprising:
providing a remote focusing all-optical digital scanning light sheet microscopy system having at least an illumination side optics, a detection objective, and image detector;
providing an electro-tunable lens positioned in a detection path of the detection objective, wherein a focal length of the electro-tunable lens is adjustable electrically as a function of electrical current supplied by a driver;
generating a light sheet, via the illumination side optics, at a first position of a first section, wherein the illumination plane of the light sheet illuminates the first section;
aligning, via the electro-tunable lens, a focal plane of the detection objective to the first position, the first position being an expected position of the illumination plane of the light sheet such that the focal plane and illumination plane coincide, wherein the detection axis of the detection objective is substantially orthogonal to the illumination plane of the light sheet;
capturing, via the image detector, a first image of the first section detected by the detection objective;
determining whether the first image of the first section is within a focus tolerance range, wherein the focus tolerance range specifies a threshold focus level for a captured image;
identifying at least one out-of-focus feature in the first image of the first section;
adjusting, via the driver of the electro-tunable lens, the focal length of the electro-tunable lens, wherein the focal plane of the detection objective is shifted to coincide with the position of the illumination plane of the light sheet at the at least one out-of-focus feature; and
capturing a second image of the first section having the at least one out-of-focus feature in focus.

22. The method of claim 21, further comprising:
scanning, via a scanning mirror of the illumination side optics, the light sheet to a position wherein the illumination plane of the light sheet illuminates a second section of the specimen;
capturing, via the image detector, a first image of the second section detected by the detection objective;
determining whether the first image of the second section is within the focus tolerance range;
identifying at least one out-of-focus feature in the first image of the second section;
adjusting, via the driver of the electro-tunable lens, the focal length of the electro-tunable lens, wherein the focal plane of the detection objective is shifted to coincide with the position of the illumination plane of the light sheet at the at least one out-of-focus feature of the second section; and
capturing a second image of the second section having the at least one out-of-focus feature of the second section in focus.
